(19) United States
(12) Patent Application Publication
(10) Pub. No.: US 2019/0101213 A1
(43) Pub. Date: Apr. 4, 2019

(54) SEALING DEVICE

(71) Applicants: THYSSENKRUPP PRESTA AG, Eschen (LI); thyssenkrupp AG, Essen (DE)

(72) Inventor: Michael WALSER, Cholula (MX)

(73) Assignees: THYSSENKRUPP PRESTA AG, Eschen (LI); thyssenkrupp AG, Essen (DE)

(21) Appl. No.: 16/094,583

(22) PCT Filed: Apr. 18, 2017
(86) PCT No.: PCT/EP2017/059112

§ 371 Date: Oct. 18, 2018

(30) Foreign Application Priority Data
Apr. 20, 2016 (DE) 10 2016 206 723.0

(51) Int. Cl. F16J 15/3264

(52) U.S. Cl. CPC F16J 15/3264; B62D 1/16

(57) ABSTRACT

A sealing device for sealing an opening of a transverse wall that separates an engine compartment from a passenger compartment of a motor vehicle and through which opening an intermediate steering shaft of a steering system is guided. The sealing device may have a resilient sealing member that covers the opening, that surrounds the intermediate steering shaft, that is secured with a first end region to the transverse wall, and that lies in a sealing manner with a second end region against an outer peripheral face of a sealing sleeve. The sealing sleeve may be secured to and may rotate with the intermediate steering shaft. The sealing device may also include an inner covering face that has radially inwardly protruding projections and that is connectable to an outer covering face of the intermediate steering shaft.

The invention relates to a sealing device for sealing an opening of a transverse wall which separates the engine compartment from the passenger compartment of a motor vehicle and through which an intermediate steering shaft of the vehicle steering system is guided, having a sealing member of resilient material which covers the opening and which surrounds the intermediate steering shaft and which is secured with a first end region to the transverse wall and which lies in a sealing manner with a second end region against an outer peripheral face of a sealing sleeve which is secured to the intermediate steering shaft and which can be rotated with the intermediate steering shaft.

Such a sealing device is known from DE 198 57 392 A1. A sealing bellows is secured, on the one hand, to a bulkhead and, on the other hand, lies in a sliding manner against a sleeve which is fixed to a steering shaft portion with an undulating outer face. The disadvantage thereof is the sleeve which is constructed in a complex manner from a plurality of components and materials and the complex fixing thereof on the steering shaft.

DE 10 2007 031 395 A1 also discloses a bulkhead wall passage of a steering shaft, wherein a sealing bellows cooperates with a sleeve. The disadvantage of this solution is that the sleeve comprises many individual components.

An object of the invention is to provide an improved sealing for a bulkhead passage which comprises a simple structure and which at the same time can be fixed in a simple manner to the steering shaft and can be assembled in a simple manner in the motor vehicle.

This object is achieved according to the invention in that the sealing sleeve comprises an inner covering face which has radially inwardly protruding projections and which by pressing onto an outer covering face of the intermediate steering shaft is connected thereto. The sealing sleeve according to the invention may advantageously be configured as an integral molded component which can be produced with little production complexity. The assembly of the sealing sleeve according to the invention is carried out by means of simple pressing on the intermediate steering shaft without, for example, two sleeve members having to be screwed to each other.

It is particularly advantageous for the sealing sleeve to comprise plastics material. This material facilitates the cost-effective production of the sealing sleeve, for example, using the injection-molding method. Furthermore, the hardness and resilience of the plastics material can be adapted to the present application of the sealing sleeve so that it can be pressed in a simple manner onto the intermediate steering shaft without cracking and subsequently the sealing sleeve clamps firmly enough to the intermediate steering shaft in order not to slide off during operation of the vehicle.

In a development of the invention, there is provision for the intermediate steering shaft to comprise a conical portion which merges into the mentioned outer covering face so that the radial projections of the sealing sleeve can be pushed over the conical portion during pressing. In this instance, the sealing sleeve is expanded in a radially resilient manner so that it is fixed in a frictionally engaging manner on the outer covering face. The conical portion of the intermediate steering shaft facilitates the pressing operation.

The invention is further improved by the radial projections in a first axial end portion of the inner covering face being arranged so as to be distributed over the inner periphery thereof and the mentioned outer covering face of the intermediate steering shaft being provided with a peripheral annular groove in which the projections engage. The securing of the sealing sleeve on the intermediate steering shaft in the correct position is thereby facilitated and the retention improved.

In an embodiment of the invention, the sealing sleeve is provided in a second axial end portion of the inner covering face with radially inwardly projecting resilient tongues which engage in recesses which extend parallel with the rotation axis on the outer side of the intermediate steering shaft. On the one hand, the second end portion of the sealing sleeve, which end portion is not in clamping engagement with the intermediate steering shaft, is thereby radially centered or fixed and, on the other hand, connected to the intermediate steering shaft in a rotationally secure manner so that a higher torque can be transmitted. The recesses which extend on the outer side of the intermediate steering shaft are for other structural reasons present in any case and do not have to be additionally introduced in order to carry out the above-mentioned step.

The fixing of the sealing sleeve on the intermediate steering shaft is further improved by two resilient tongues which are arranged in a mutually adjacent manner in pairs engaging in a recess. In this instance, the resilient tongues which are adjacent in pairs lie resiliently against opposing flanks of the recess so that the sealing sleeve is fixed in a play-free manner to the intermediate steering shaft and cannot rattle.

The object is also achieved with a method for sealing a passage of an intermediate steering shaft through a transverse wall of a motor vehicle, wherein the intermediate steering shaft is provided with a sealing sleeve and the sealing member and with the sealing sleeve and the sealing member is introduced through an opening in the transverse wall from a passenger compartment side of the vehicle, wherein the sealing member is secured to the transverse wall.

As a result of the fact that the intermediate steering shaft is provided before being introduced through the opening in the transverse wall with both the sealing sleeve and the sealing member, a simple and time-saving assembly in the vehicle can be carried out since the intermediate steering shaft together with the sealing sleeve and the sealing member forms a subassembly which in an assembly step is pushed through the opening of the transverse wall. If the correct assembly position is reached, the sealing member is coupled to the transverse wall in which a first end region of the sealing member is connected in a sealing manner to the transverse wall.

Preferably, the sealing sleeve comprises an inner covering face with radially inwardly protruding projections which are pressed onto an outer covering face of the intermediate steering shaft.

An embodiment of the invention is explained in greater detail below with reference to the drawings. In detail in the Figures:

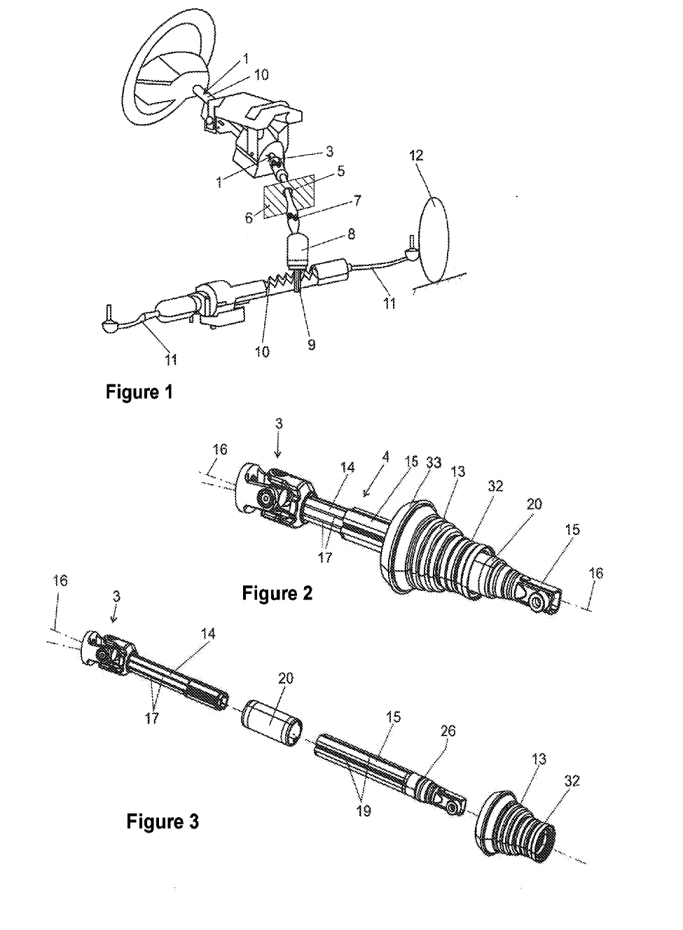

FIG. 1: is a schematic illustration of a steering device for motor vehicles with an intermediate steering shaft introduced through a transverse wall;

FIG. 2: shows an intermediate steering shaft with a sealing member and sealing sleeve in the assembled state;

FIG. 3: shows the components from FIG. 2 prior to assembly;

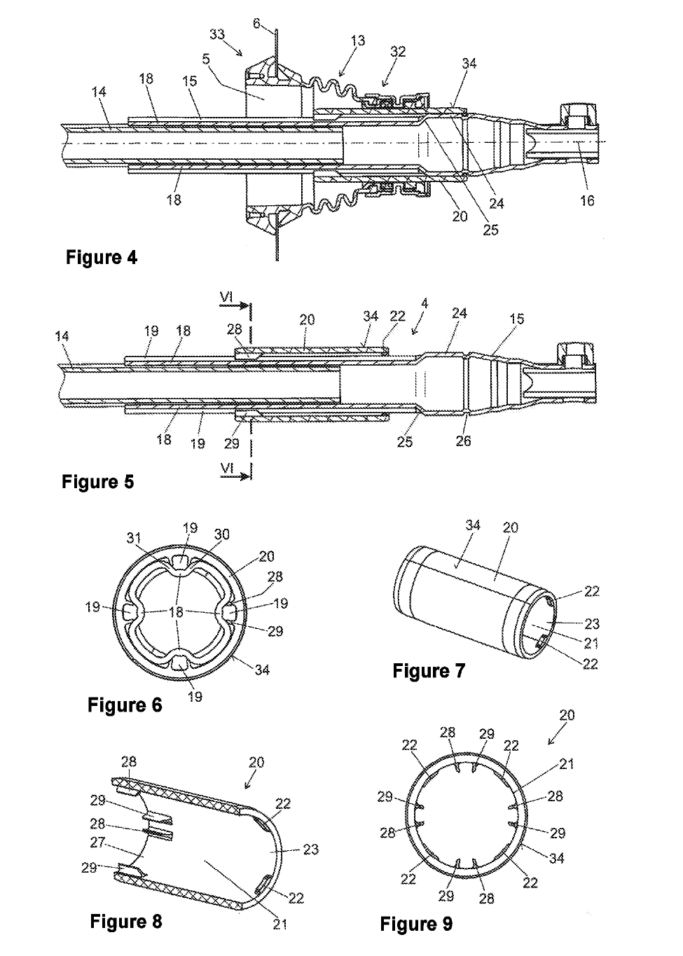

FIG. 4: is a sectioned illustration of an intermediate steering shaft with the sealing device according to the invention;

FIG. 5: is a sectioned illustration of an intermediate steering shaft with a sealing sleeve not yet fully pressed on;

FIG. 6: is a cross-section of an intermediate steering shaft along line VI-VI from FIG. 5;

FIG. 7: is a perspective illustration of a sealing sleeve;

FIG. 8: is a perspective illustration of the inner space of a cut-open sealing sleeve;

FIG. 9: is a side view of a sealing sleeve according to the invention.

FIG. 1 shows a steering device for a motor vehicle in which a steering shaft 1 is connected at one end to a steering wheel 2 and at the other end thereof via a rotary joint 3 which is constructed as a universal joint to an intermediate steering shaft 4. The intermediate steering shaft 4 is guided through an opening 5 of a transverse wall 6 which is constructed as a bulkhead and which separates the passenger compartment of the vehicle from the engine compartment. Via an additional rotary joint 7, the intermediate steering shaft 4 is connected to a steering gear mechanism 8 which acts via a pinion 9 on a toothed rack 10. The toothed rack is depending on the desired steering direction displaced to the left or to the right. The movement is transmitted via two tie rods 11 to the steered vehicle wheels 12, of which in FIG. 1 only the left front wheel is illustrated.

FIG. 2 shows the intermediate steering shaft 4 with the rotary joint 3 and a sealing member 13 which is constructed in this instance as a rubber bellows. The intermediate steering shaft 4 comprises two components which can be pushed one into the other in the manner of a telescope, wherein an inner steering shaft portion 14 is inserted in an outer steering shaft portion 15 in a torque conducting manner and is arranged so as to be able to be displaced with respect thereto in the direction of the rotation axis 16 of the intermediate steering shaft 4. The inner steering shaft portion 14 is provided at the outer side thereof with grooves 17 which extend parallel with the rotation axis 16 and in which radially inwardly protruding ridges 18 of the outer steering shaft portion 15, which also extend along the rotation axis 16, engage so that the inner steering shaft portion 14 are also connected to the outer steering shaft portion 15 in a rotationally secure manner in the event of axial displacement relative to each other in order thus to transmit the steering torque. The ridges 18 are formed in the material of the outer steering shaft portion 15, wherein there are produced on the outer periphery of the outer steering shaft portion 15 recesses 19 which also extend in the direction of the rotation axis 16.

In all the FIGS. 2 to 9, it is possible to see a sealing sleeve 20 according to the invention which is produced as an integral injection-molded component of plastics material. On an inner covering face 21 of the sealing sleeve 20 there are provided projections 22 which protrude radially inward. The projections 22 are located in a first axial end portion 23 of the inner covering face 21 and a total of four projections 22 are arranged so as to be distributed over the inner periphery.

The projections 22 serve to fix the sealing sleeve 20 to the outer steering shaft portion 15 of the intermediate steering shaft 4. In this instance, the sealing sleeve 20 is pushed from the position which is illustrated in FIG. 3 in the direction of the rotation axis 16 onto the outer steering shaft portion 15 until it assumes the position shown in FIG. 2 or 4. In this instance, the projections 22 move into clamping engagement with the outer covering face 24 of the outer steering shaft portion 15. The outer covering face 24 which acts in this instance as a clamping portion is constructed to be slightly larger in terms of diameter than the portion of the outer steering shaft portion 15 which cooperates with the inner steering shaft portion 14. In order to facilitate the pressing of the sealing sleeve 20 onto the clamping portion 24, the clamping portion 24 merges into a conical portion 25 which itself merges into the portion of the outer steering shaft portion 15 which has a smaller diameter and which cooperates with the inner steering shaft portion 14. When the sealing sleeve 20 is pressed on, it is guided forward over the portion with a smaller diameter and strikes with the projections 22 thereof against the conical portion 25. If the pressing movement is continued, the sealing sleeve 20 expands slightly in the first axial end portion 23 thereof, wherein the projections 22 are pushed onto the outer covering face 24 of the clamping portion of the outer steering shaft portion 15 where, as a result of the resilience of the sealing sleeve 20, they remain in fixed frictional engagement with the outer steering shaft portion 15.

In order to fix the axial position of the sealing sleeve 20 on the outer steering shaft portion 15, it can additionally be provided with a peripheral annular groove 26 in which the projections 22 of the sealing sleeve 20 engage.

As can best be seen in FIGS. 6, 8 and 9, the sealing sleeve 20 is provided in a second axial end portion 27 with radially inwardly protruding resilient tongues 28, 29 which engage in recesses 19 which extend parallel with the rotation axis 16 at the outer side of the outer steering shaft portion 15 of the intermediate steering shaft 4. The resilient tongues 28, 29 are arranged in an adjacent manner in pairs and with the sealing sleeve 20 assembled lie against the flanks 30, 31 of the recesses 19. The sealing sleeve 20 is thereby, on the one hand, fixed in a centered manner and remains, on the other hand, connected without any play in the rotation direction to the outer steering shaft portion 15 so that it can transmit torque and does not rattle.

After the sealing sleeve 20 has been mounted on the intermediate steering shaft 4, the sealing member 13 is mounted. The sealing member surrounds the intermediate steering shaft 4 or more specifically the rotation axis 16 of the intermediate steering shaft 4 completely. To this end, the sealing member 13 is constructed at the second end region 32 thereof which cooperates with the sealing sleeve 20 as an annular sealing portion 32 which lies in a sealing manner against an outer peripheral face 34 of the sealing sleeve 20, wherein the sealing sleeve 20 can rotate within the sealing portion 32. A first end region 33 of the sealing member 13 which is connected to the transverse wall 6 is arranged at the other end of the sealing member 13. The end region 33 clamps the edges of the opening 5 of the transverse wall 6 and thus seals the opening 5.

The sealing sleeve 20 according to the invention can be produced in a simple manner, for example, with an injection-molding method, from plastics material and can also be assembled in a simple manner by pressing on the intermediate steering shaft. The present invention thus differs from sealing sleeves of the prior art which have multiple components and which are complex to assemble.

### LIST OF REFERENCE NUMERALS

1 Steering shaft
2 Steering wheel
3 Rotary joint
4 Intermediate steering shaft
5 Opening
6 Transverse wall
7 Rotary joint
8 Steering gear mechanism
9 Pinion
10 Toothed rack
11 Tie rod
12 Vehicle wheel
13 Sealing member
14 Inner steering shaft portion
15 Outer steering shaft portion
16 Rotation axis
17 Grooves
18 Ridges
19 Recesses
20 Sealing sleeve
21 Inner covering face
22 Projections
23 First axial end portion
24 Clamping portion
25 Conical portion
26 Annular groove
27 Second axial end portion
28 Resilient tongue
29 Resilient tongue
30 Flank
31 Flank
32 Second end region, sealing portion
33 First end region
34 Outer peripheral face

1.-8. (canceled)

9. A sealing device for sealing an opening of a transverse wall that separates an engine compartment from a passenger compartment of a motor vehicle and through which opening an intermediate steering shaft of a steering system is guided, the sealing device comprising:
a sealing sleeve with an outer peripheral face, the sealing sleeve being secured to and rotatable with the intermediate steering shaft, wherein the sealing sleeve comprises an inner covering face that has radially inwardly protruding projections and that is connectable to an outer covering face of the intermediate steering shaft by pressing the inner covering face onto the outer covering face; and
a sealing member comprised of resilient material that covers the opening, that surrounds the intermediate steering shaft, that is secured with a first end region to the transverse wall, and that lies in a sealing manner with a second end region against the outer peripheral face of the sealing sleeve.

10. The sealing device of claim 9 wherein the sealing sleeve comprises plastic.

11. The sealing device of claim 9 wherein the intermediate steering shaft comprises a conical portion that merges into the outer covering face so that the radially inwardly protruding projections of the sealing sleeve can be pushed over the conical portion as the inner covering face is pressed onto the outer covering face of the intermediate steering shaft.

12. The sealing device of claim 9 wherein in a first axial end portion of the inner covering face, the radially inwardly protruding projections are distributed over an inner periphery of the inner covering face, wherein the outer covering face of the intermediate steering shaft includes a peripheral annular groove in which the radially inwardly protruding projections engage.

13. The sealing device of claim 12 wherein in a second axial end portion of the inner covering face, radially inwardly projecting tongues engage in recesses that extend parallel to a rotation axis on an outer side of the intermediate steering shaft.

14. The sealing device of claim 13 wherein the radially inwardly projecting tongues are arranged in pairs, wherein each of the pairs engages in one of the recesses.

15. A method for sealing a passage of an intermediate steering shaft through a transverse wall of a motor vehicle, the method comprising:
providing the intermediate steering shaft with a sealing sleeve and a sealing member;
introducing the intermediate steering shaft with the sealing sleeve and the sealing member through an opening in the transverse wall from a passenger compartment side; and
securing the sealing member to the transverse wall.

16. The method of claim 15 wherein
the sealing sleeve has an outer peripheral face, the sealing sleeve being secured to and rotatable with the intermediate steering shaft, wherein the sealing sleeve comprises an inner covering face that has radially inwardly protruding projections and that is connected to an outer covering face of the intermediate steering shaft by pressing the inner covering face onto the outer covering face; and
the sealing member is comprised of resilient material that covers the opening, that surrounds the intermediate steering shaft, that is secured with a first end region to the transverse wall, and that lies in a sealing manner with a second end region against the outer peripheral face of the sealing sleeve.

17. The method of claim 15 wherein the sealing sleeve comprises an inner covering face with radially inwardly protruding projections, the method comprising pressing the radially inwardly protruding projections onto an outer covering face of the intermediate steering shaft.
